(19) United States
(12) Patent Application Publication
(10) Pub. No.: US 2026/0151883 A1
(43) Pub. Date: Jun. 4, 2026

(54) ELECTRIC TOOL SYSTEM WITH TORQUE-CORRECTING FUNCTION AND FORCE-MULTIPLIER TORQUE-TESTING SYSTEM

(71) Applicant: MATATAKITOYO TOOL CO., LTD., Taichung City (TW)

(72) Inventor: Yi-Min WU, Taichung City (TW)

(21) Appl. No.: 18/966,482

(22) Filed: Dec. 3, 2024

(51) Int. Cl. B25B 23/147

(52) U.S. Cl. CPC B25B 23/1475

(57) ABSTRACT

An electric tool system with a torque-correcting function includes an electric tool apparatus and a force-multiplier apparatus. The force-multiplier apparatus is assembled to the electric tool apparatus. The force-multiplier apparatus is configured to transmit a torque test data and a torque original data to the electric tool apparatus. The electric tool apparatus is configured to calculate the torque test data and the torque original data to obtain a torque correction data. The electric tool apparatus is configured to drive the force-multiplier apparatus to rotate based on the torque correction data.

### BACKGROUND OF THE DISCLOSURE

### Technical Field

The present disclosure relates to an electric tool system and a torque-testing system, and especially relates to an electric tool system with a torque-correcting function and a force-multiplier torque-testing system.

### Description of Related Art

The principle of the force multiplier is to generate a large output torque by inputting a smaller force through the difference of the high-efficiency gear ratio.

Currently, the electric tool may set the output torque value. When the electric tool reaches the set torque value, the electric tool may idle or stop outputting torque.

The maximum output torque value of a certain electric tool is, for example, 50 Nm, but since the construction requires the torque of 500 Nm, a force multiplier is needed to increase the torque; in this case, the electric tool may be equipped with a force multiplier with a torque ratio of one to ten (namely, 10) and an output torque of 500 Nm; in this way, the electric tool with the maximum output torque value of 50 Nm may obtain a torque of 500 Nm through this force multiplier.

However, the force multiplier may produce a torque error after long-term use, and this problem needs to be solved urgently.

### SUMMARY OF THE INVENTION

In order to solve the above-mentioned problems, an object of the present disclosure is to provide an electric tool system with a torque-correcting function.

In order to solve the above-mentioned problems, another object of the present disclosure is to provide a force-multiplier torque-testing system.

In order to achieve the object of the present disclosure mentioned above, the electric tool system of the present disclosure includes an electric tool apparatus and a force-multiplier apparatus. The force-multiplier apparatus is assembled to the electric tool apparatus. Moreover, the force-multiplier apparatus is configured to transmit a torque test data and a torque original data to the electric tool apparatus. The electric tool apparatus is configured to calculate the torque test data and the torque original data to obtain a torque correction data. The electric tool apparatus is configured to drive the force-multiplier apparatus to rotate based on the torque correction data.

Moreover, in an embodiment of the electric tool system of the present disclosure mentioned above, the force-multiplier apparatus includes a force-multiplier-end memory, a processor, and a force-multiplier-end signal-transmitting circuit. The force-multiplier-end memory is configured to store the torque test data and the torque original data. The processor is electrically connected to the force-multiplier-end memory. The force-multiplier-end signal-transmitting circuit is electrically connected to the processor and the electric tool apparatus. Moreover, the processor is configured to obtain the torque test data and the torque original data from the force-multiplier-end memory. The processor is configured to transmit the torque test data and the torque original data to the electric tool apparatus through the force-multiplier-end signal-transmitting circuit.

Moreover, in an embodiment of the electric tool system of the present disclosure mentioned above, the electric tool apparatus includes a tool-end signal-transmitting circuit and a control circuit. The tool-end signal-transmitting circuit is electrically connected to the force-multiplier-end signal-transmitting circuit. The control circuit is electrically connected to the tool-end signal-transmitting circuit. Moreover, the processor is configured to transmit the torque test data and the torque original data to the control circuit through the force-multiplier-end signal-transmitting circuit and the tool-end signal-transmitting circuit. The control circuit is configured to calculate the torque test data and the torque original data to obtain the torque correction data. The control circuit is configured to drive the force-multiplier apparatus to rotate based on the torque correction data.

Moreover, in an embodiment of the electric tool system of the present disclosure mentioned above, the electric tool apparatus further includes a tool-end memory electrically connected to the control circuit. Moreover, the control circuit is configured to transmit the torque correction data to the tool-end memory to store the torque correction data. The control circuit is configured to drive the force-multiplier apparatus to rotate based on the torque correction data stored in the tool-end memory.

Moreover, in an embodiment of the electric tool system of the present disclosure mentioned above, the force-multiplier-end signal-transmitting circuit and the tool-end signal-transmitting circuit are, for example but not limited to, conductive pins, connectors, or wireless transmission circuits.

Moreover, in an embodiment of the electric tool system of the present disclosure mentioned above, the electric tool apparatus further includes a power-transmitting group and a tool force-outputting-end structure. The power-transmitting group is connected to the control circuit. The tool force-outputting-end structure is connected to the power-transmitting group and the force-multiplier apparatus. Moreover, the force-multiplier apparatus further includes a gear set, a force-multiplier force-outputting-end structure, and a force-multiplier force-inputting-end structure. The gear set is connected to the processor. The force-multiplier force-outputting-end structure is connected to the gear set. The force-multiplier force-inputting-end structure is connected to the gear set and the tool force-outputting-end structure. Moreover, the control circuit is configured to drive the power-transmitting group to drive the tool force-outputting-end structure to rotate based on the torque correction data stored in the tool-end memory, so that the force-multiplier force-inputting-end structure is configured to be rotated by the tool force-outputting-end structure to drive the gear set, so that the gear set is configured to be driven by the force-multiplier force-inputting-end structure to rotate the force-multiplier force-outputting-end structure.

In order to achieve the another object of the present disclosure mentioned above, the force-multiplier torque-testing system of the present disclosure includes a torque-testing apparatus and a force-multiplier apparatus. The force-multiplier apparatus is connected to the torque-testing apparatus. Moreover, the torque-testing apparatus is configured to test the force-multiplier apparatus to obtain a torque test data. The torque-testing apparatus is configured to transmit the torque test data to the force-multiplier apparatus. The force-multiplier apparatus is configured to store the torque test data.

Moreover, in an embodiment of the force-multiplier torque-testing system of the present disclosure mentioned above, the force-multiplier apparatus includes a force-multiplier-end memory, a processor, and a force-multiplier-end signal-transmitting circuit. The force-multiplier-end memory is configured to store the torque test data. The processor is electrically connected to the force-multiplier-end memory. The force-multiplier-end signal-transmitting circuit is electrically connected to the processor and the torque-testing apparatus. Moreover, the torque-testing apparatus includes a detection shaft structure, a testing-end signal-transmitting circuit, and a torque-testing circuit. The detection shaft structure is connected to the force-multiplier apparatus. The testing-end signal-transmitting circuit is electrically connected to the force-multiplier-end signal-transmitting circuit. The torque-testing circuit is electrically connected to the testing-end signal-transmitting circuit and is connected to the detection shaft structure. Moreover, the torque-testing circuit is configured to test the force-multiplier apparatus through the detection shaft structure to obtain the torque test data. The torque-testing circuit is configured to transmit the torque test data to the processor through the testing-end signal-transmitting circuit and the force-multiplier-end signal-transmitting circuit. The processor is configured to transmit the torque test data to the force-multiplier-end memory to store the torque test data.

Moreover, in an embodiment of the force-multiplier torque-testing system of the present disclosure mentioned above, the force-multiplier apparatus further includes a gear set, a force-multiplier force-outputting-end structure, and a force-multiplier force-inputting-end structure. The gear set is connected to the processor. The force-multiplier force-outputting-end structure is connected to the gear set and the detection shaft structure. The force-multiplier force-inputting-end structure is connected to the gear set. Moreover, the force-multiplier force-inputting-end structure is configured to be rotated to drive the gear set, so that the gear set is configured to be driven by the force-multiplier force-inputting-end structure to rotate the force-multiplier force-outputting-end structure to drive the detection shaft structure, so that the torque-testing circuit is configured to test the force-multiplier apparatus through the detection shaft structure to obtain the torque test data. Moreover, the torque-testing apparatus further includes a display electrically connected to the torque-testing circuit. Moreover, the torque-testing circuit is configured to transmit the torque test data to the display to display the torque test data.

Moreover, in an embodiment of the force-multiplier torque-testing system of the present disclosure mentioned above, the force-multiplier-end signal-transmitting circuit and the testing-end signal-transmitting circuit are, for example but not limited to, conductive pins, connectors, or wireless transmission circuits.

The advantage of the present disclosure is to enable the electric tool equipped with the force multiplier to provide the accurate torque.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a block diagram of the force-multiplier torque-testing system of the present disclosure.

FIG. 2 shows a schematic side cross-sectional view of the torque-testing apparatus of the present disclosure.

FIG. 3 shows a schematic diagram of the appearance of the force-multiplier apparatus of the present disclosure.

FIG. 4 shows a block diagram of the electric tool system with a torque-correcting function of the present disclosure.

FIG. 5 shows a schematic diagram of the appearance of the electric tool apparatus of the present disclosure.

FIG. 6 shows a schematic diagram of the force-multiplier apparatus assembled to the electric tool apparatus of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

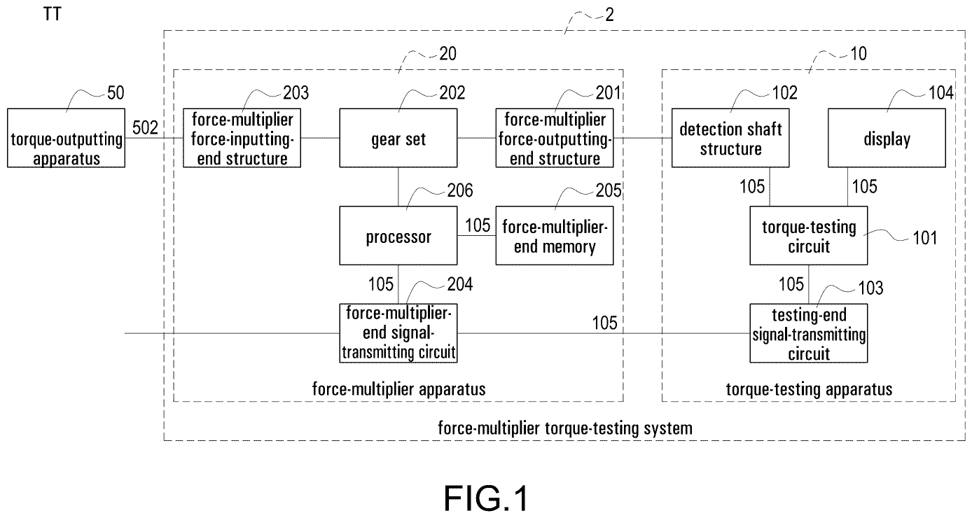

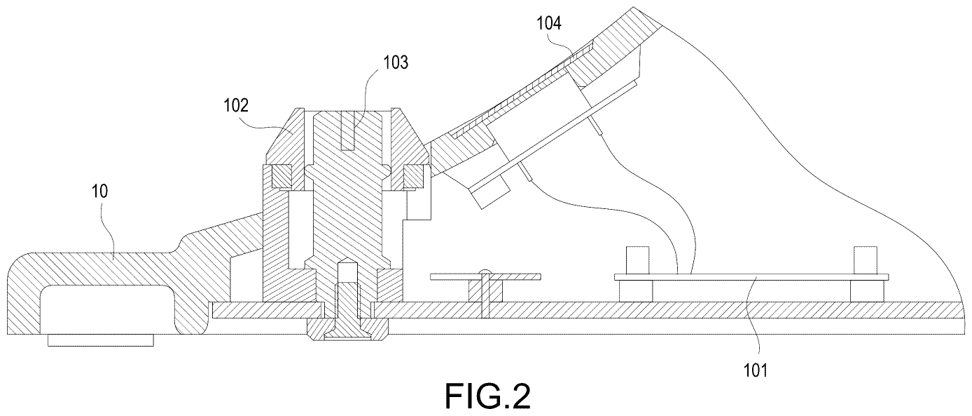

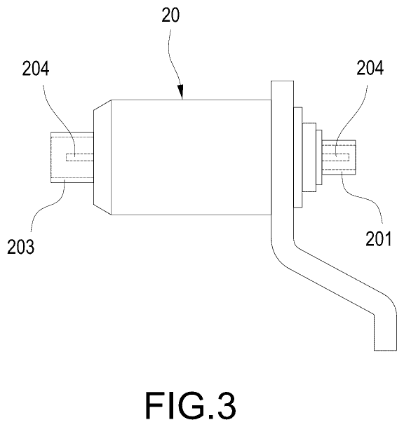

FIG. 1 shows a block diagram of the force-multiplier torque-testing system 2 of the present disclosure. FIG. 2 shows a schematic side cross-sectional view of the torque-testing apparatus 10 of the present disclosure. FIG. 3 shows a schematic diagram of the appearance of the force-multiplier apparatus 20 of the present disclosure. Please refer to FIG. 1, FIG. 2, and FIG. 3 at the same time. The force-multiplier torque-testing system 2 of the present disclosure is applied to a torque-outputting apparatus 50. The force-multiplier torque-testing system 2 includes a torque-testing apparatus 10 and a force-multiplier apparatus 20. The force-multiplier apparatus 20 is connected to the torque-testing apparatus 10 and the torque-outputting apparatus 50. The torque-outputting apparatus 50 is, for example but not limited to, a hand tool, an electric tool, or a special tool (for example, a test tool provided with the torque-testing apparatus 10).

The torque-testing apparatus 10 includes a torque-testing circuit 101, a detection shaft structure 102, a testing-end signal-transmitting circuit 103, and a display 104. The force-multiplier apparatus 20 includes a force-multiplier force-outputting-end structure 201, a gear set 202, a force-multiplier force-inputting-end structure 203, a force-multiplier-end signal-transmitting circuit 204, a force-multiplier-end memory 205, and a processor 206. The force-multiplier-end signal-transmitting circuit 204 and the testing-end signal-transmitting circuit 103 are, for example but not limited to, conductive pins, connectors, or wireless transmission circuits. The wireless transmission circuits are Wi-Fi modules or Bluetooth modules.

Moreover, in terms of the actual structure, the testing-end signal-transmitting circuit 103 is, for example but not limited to, arranged within the detection shaft structure 102 (as shown in FIG. 2); the force-multiplier-end signal-transmitting circuit 204 is, for example but not limited to, arranged within the force-multiplier force-outputting-end structure 201 and the force-multiplier force-inputting-end structure 203 (as shown in FIG. 3).

The detection shaft structure 102 is connected to the force-multiplier force-outputting-end structure 201 and the torque-testing circuit 101. The torque-testing circuit 101 is further electrically connected to the testing-end signal-transmitting circuit 103 and the display 104. The testing-end signal-transmitting circuit 103 is further electrically connected to the force-multiplier-end signal-transmitting circuit 204.

The force-multiplier force-outputting-end structure 201 is connected to the gear set 202 and the detection shaft structure 102 (for example, the force-multiplier force-outputting-end structure 201 is assembled to one end of an external sleeve (not shown in FIG. 1, FIG. 2, or FIG. 3; for example, an inter-hexagonal nut), and the other end of the external sleeve is sleeved on the detection shaft structure 102). The gear set 202 is further connected to the processor 206 and the force-multiplier force-inputting-end structure 203. The force-multiplier force-inputting-end structure 203 is further connected to the torque-outputting apparatus 50. The processor 206 is further electrically connected to the force-multiplier-end memory 205 and the force-multiplier-end signal-transmitting circuit 204.

The force-multiplier force-inputting-end structure 203 is configured to be rotated by the torque-outputting apparatus 50 to drive the gear set 202, so that the gear set 202 is configured to be driven by the force-multiplier force-inputting-end structure 203 to rotate the force-multiplier force-outputting-end structure 201 to drive the detection shaft structure 102, so that the torque-testing circuit 101 is configured to test the force-multiplier apparatus 20 through the detection shaft structure 102 to obtain a torque test data 105.

The torque-testing circuit 101 is configured to transmit the torque test data 105 to the display 104 to display the torque test data 105. The torque-testing circuit 101 is configured to transmit the torque test data 105 to the processor 206 through the testing-end signal-transmitting circuit 103 and the force-multiplier-end signal-transmitting circuit 204. The processor 206 is configured to transmit the torque test data 105 to the force-multiplier-end memory 205 to store the torque test data 105.

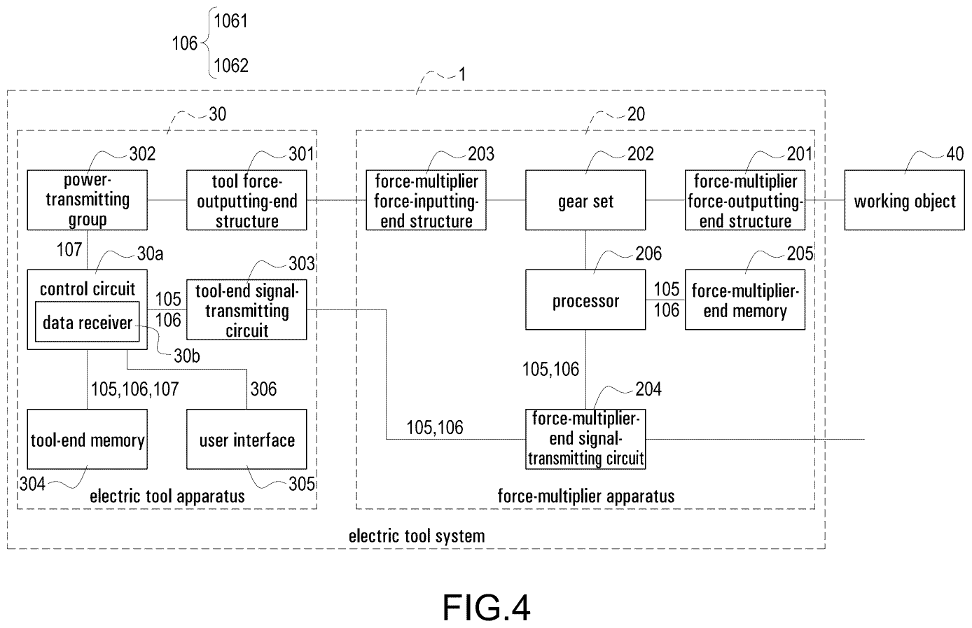

Moreover, after the force-multiplier-end memory 205 of the force-multiplier apparatus 20 stores the torque test data 105, the torque-testing apparatus 10 and the torque-outputting apparatus 50 are removed from the force-multiplier apparatus 20, and the force-multiplier force-inputting-end structure 203 and the force-multiplier-end signal-transmitting circuit 204 of the force-multiplier apparatus 20 are connected to the electric tool apparatus 30 which is shown in FIG. 4, and the force-multiplier force-outputting-end structure 201 of the force-multiplier apparatus 20 is connected to a working object 40 which is shown in FIG. 4, and the force-multiplier apparatus 20 is configured to transmit the torque test data 105 and a torque original data 106 to the electric tool apparatus 30, and the electric tool apparatus 30 calculates the torque test data 105 and the torque original data 106 to obtain a torque correction data 107, and the electric tool apparatus 30 drives the force-multiplier apparatus 20 to rotate based on the torque correction data 107 to rotate the working object 40; the above content will be described in detail later.

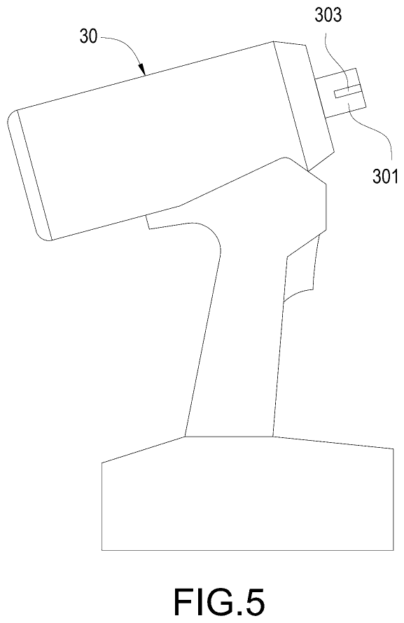

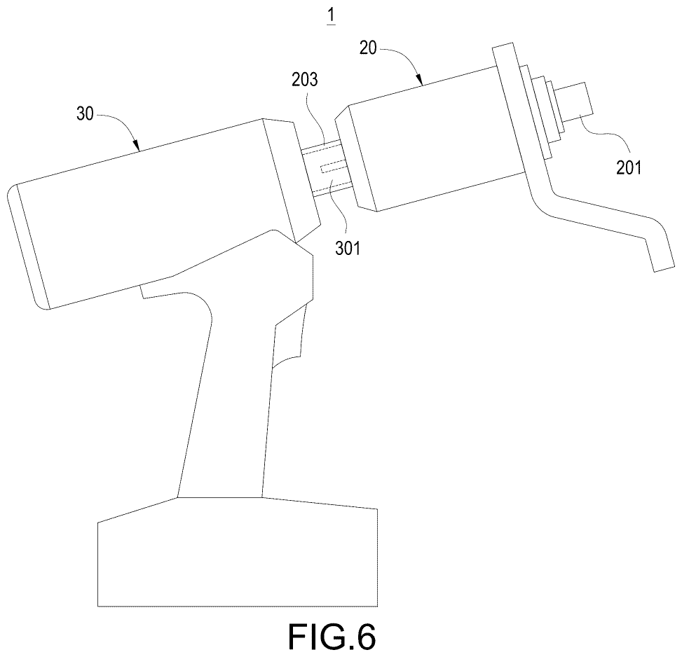

FIG. 4 shows a block diagram of the electric tool system 1 with a torque-correcting function of the present disclosure. FIG. 5 shows a schematic diagram of the appearance of the electric tool apparatus 30 of the present disclosure. FIG. 6 shows a schematic diagram of the force-multiplier apparatus 20 assembled to the electric tool apparatus 30 of the present disclosure. Please refer to FIG. 3, FIG. 4, FIG. 5, and FIG. 6 at the same time. The electric tool system 1 of the present disclosure is applied to a working object 40. The electric tool system 1 includes an electric tool apparatus 30 and the force-multiplier apparatus 20 mentioned above. The force-multiplier apparatus 20 is assembled to the electric tool apparatus 30. The working object 40 is, for example but not limited to, a screw or a bolt.

The force-multiplier apparatus 20 includes a force-multiplier force-outputting-end structure 201, a gear set 202, a force-multiplier force-inputting-end structure 203, a force-multiplier-end signal-transmitting circuit 204, a force-multiplier-end memory 205, and a processor 206. The electric tool apparatus 30 includes a control circuit 30a, a tool force-outputting-end structure 301, a power-transmitting group 302, a tool-end signal-transmitting circuit 303, and a tool-end memory 304. The force-multiplier-end signal-transmitting circuit 204 and the tool-end signal-transmitting circuit 303 are, for example but not limited to, conductive pins, connectors, or wireless transmission circuits. The wireless transmission circuits are Wi-Fi modules or Bluetooth modules. The control circuit 30a is, for example but not limited to, a processor or a controller. The power-transmitting group 302 is, for example but not limited to, a motor.

Moreover, in terms of the actual structure, the tool-end signal-transmitting circuit 303 is, for example but not limited to, arranged within the tool force-outputting-end structure 301 (as shown in FIG. 5); the force-multiplier-end signal-transmitting circuit 204 is, for example but not limited to, arranged within the force-multiplier force-outputting-end structure 201 and the force-multiplier force-inputting-end structure 203 (as shown in FIG. 3).

The force-multiplier force-outputting-end structure 201 is connected to the gear set 202 and the working object 40. The gear set 202 is further connected to the processor 206 and the force-multiplier force-inputting-end structure 203. The force-multiplier force-inputting-end structure 203 is further connected to the tool force-outputting-end structure 301. The processor 206 is further electrically connected to the force-multiplier-end memory 205 and the force-multiplier-end signal-transmitting circuit 204. The force-multiplier-end signal-transmitting circuit 204 is further electrically connected to the tool-end signal-transmitting circuit 303. The power-transmitting group 302 is connected to the control circuit 30a and the tool force-outputting-end structure 301. The control circuit 30a is further electrically connected to the tool-end signal-transmitting circuit 303 and the tool-end memory 304.

The force-multiplier-end memory 205 is configured to store a torque test data 105 and a torque original data 106. The processor 206 is configured to obtain the torque test data 105 and the torque original data 106 from the force-multiplier-end memory 205. The processor 206 is configured to transmit the torque test data 105 and the torque original data 106 to the control circuit 30a through the force-multiplier-end signal-transmitting circuit 204 and the tool-end signal-transmitting circuit 303. Moreover, the control circuit 30a includes a data receiver 30b for receiving the torque test data 105 and the torque original data 106.

The control circuit 30a is configured to calculate the torque test data 105 and the torque original data 106 to obtain a torque correction data 107. The control circuit 30a is configured to transmit the torque test data 105, the torque original data 106, and the torque correction data 107 to the tool-end memory 304 to store the torque test data 105, the torque original data 106, and the torque correction data 107. The control circuit 30a is configured to drive the power-transmitting group 302 to drive the tool force-outputting-end structure 301 to rotate based on the torque correction data 107 stored in the tool-end memory 304, so that the force-multiplier force-inputting-end structure 203 is configured to be rotated by the tool force-outputting-end structure 301 to drive the gear set 202, so that the gear set 202 is configured to be driven by the force-multiplier force-inputting-end structure 203 to rotate the force-multiplier force-outputting-end structure 201 to rotate the working object 40.

Moreover, before the processor 206 of the force-multiplier apparatus 20 transmits the torque test data 105 and the torque original data 106 to the control circuit 30a of the electric tool apparatus 30 through the force-multiplier-end signal-transmitting circuit 204 and the tool-end signal-transmitting circuit 303, the electric tool apparatus 30 and the working object 40 are removed from the force-multiplier apparatus 20, and as mentioned above, the force-multiplier force-inputting-end structure 203 of the force-multiplier apparatus 20 is connected to the torque-outputting apparatus 50 which is shown in FIG. 1, and the force-multiplier force-outputting-end structure 201 and the force-multiplier-end signal-transmitting circuit 204 of the force-multiplier apparatus 20 is connected to the torque-testing apparatus 10 which is shown in FIG. 1, and the torque-testing apparatus 10 tests the force-multiplier apparatus 20 to obtain the torque test data 105, and the torque-testing apparatus 10 transmits the torque test data 105 to the force-multiplier apparatus 20, and the force-multiplier-end memory 205 of the force-multiplier apparatus 20 is configured to store the torque test data 105.

Moreover, in one embodiment of the present disclosure but without limiting the present disclosure, the electric tool apparatus 30 further includes a user interface 305 electrically connected to the control circuit 30a. The user interface 305 is configured to transmit a torque requirement data 306 to the control circuit 30a. The torque original data 106 includes a torque ratio data 1061 and a maximum output torque data 1062. The control circuit 30a is configured to calculate the torque requirement data 306, the torque test data 105, and the torque original data 106 (namely, the torque ratio data 1061 and the maximum output torque data 1062) to obtain the torque correction data 107; namely, control circuit 30a is configured to calculate: the torque correction data 107=the torque requirement data 306/[the torque ratio data 1061*(the torque test data 105/the maximum output torque data 1062)].

For example, after the force-multiplier apparatus 20 is manufactured, the force-multiplier-end memory 205 of the force-multiplier apparatus 20 stores that the torque ratio data 1061 is one to ten (namely, 10) and the maximum output torque data 1062 is 500 Nm. The force-multiplier apparatus 20 may produce a torque error after long-term use. At this time, the torque-testing apparatus 10 and the torque-outputting apparatus 50 are connected to the force-multiplier apparatus 20 to test the force-multiplier apparatus 20 to obtain the torque test data 105 which is only 400 Nm, wherein the torque-outputting apparatus 50 applies an external torque 502 (which is shown in FIG. 1) which is sufficient to the force-multiplier apparatus 20 during testing in an attempt to enable the force-multiplier apparatus 20 to output the maximum output torque data 1062 (500 Nm). For example, the force-multiplier apparatus 20 notifies the torque-outputting apparatus 50 that the torque ratio data 1061 of the force-multiplier apparatus 20 is one to ten (namely, 10) and the maximum output torque data 1062 of the force-multiplier apparatus 20 is 500 Nm, or by reading the instruction manual or the shell label of the force-multiplier apparatus 20, the user knows that the torque ratio data 1061 of the force-multiplier apparatus 20 is one to ten (namely, 10) and the maximum output torque data 1062 of the force-multiplier apparatus 20 is 500 Nm. Therefore, the external torque 502 applied by the torque-outputting apparatus 50 (controllable by the user) to the force-multiplier apparatus 20 during testing is 50 Nm (500/10=50).

Then, the torque-testing apparatus 10 and the torque-outputting apparatus 50 are removed from the force-multiplier apparatus 20, and the electric tool apparatus 30 is connected to the force-multiplier apparatus 20 to receive the torque ratio data 1061 (one to ten (namely, 10)), the maximum output torque data 1062 (500 Nm), and the torque test data 105 (400 Nm) provided by the force-multiplier apparatus 20. Then, the user interface 305 transmits the torque requirement data 306 which is 400 Nm to the control circuit 30a. The control circuit 30a calculates: the torque correction data 107=the torque requirement data 306/[the torque ratio data 1061*(the torque test data 105/the maximum output torque data 1062)]=400 Nm/[10*(400 Nm/500 Nm)]=50 Nm.

In other words, without the correction of the present disclosure, when the user connects the force multiplier having the torque ratio which is one to ten and the maximum output torque which is 500 Nm to the electric tool and expects to obtain the output torque which is 400 Nm from the force multiplier, the user would think that he only needs to control the torque which is applied by the electric tool to the force multiplier to be 40 Nm (400/10=40). However, from the above embodiments of the present disclosure, it may be seen that the torque applied by the electric tool apparatus 30 to the force-multiplier apparatus 20 must reach 50 Nm so that the output torque of the force-multiplier apparatus 20 may reach 400 Nm.

In summary, the force-multiplier apparatus 20 may produce a torque error after long-term use. The present disclosure uses the torque-testing apparatus 10 to test the force-multiplier apparatus 20 to learn the torque error and store the torque error in the force-multiplier apparatus 20. When the electric tool apparatus 30 is connected to the force-multiplier apparatus 20, the electric tool apparatus 30 may know the torque error to calculate the torque which compensates (namely, adds or subtracts) the torque error, so as to avoid locking the working object 40 too tightly (which may cause breakage or collapse) or too loosely (which may cause loosening).

The advantage of the present disclosure is to enable the electric tool equipped with the force multiplier to provide the accurate torque.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. An electric tool system with a torque-correcting function comprising:
an electric tool apparatus; and
a force-multiplier apparatus assembled to the electric tool apparatus,
wherein the force-multiplier apparatus is configured to transmit a torque test data and a torque original data to the electric tool apparatus; the electric tool apparatus is configured to calculate the torque test data and the torque original data to obtain a torque correction data; the electric tool apparatus is configured to drive the force-multiplier apparatus to rotate based on the torque correction data.

2. The electric tool system of claim 1, wherein the force-multiplier apparatus comprises:
a force-multiplier-end memory configured to store the torque test data and the torque original data;
a processor electrically connected to the force-multiplier-end memory; and
a force-multiplier-end signal-transmitting circuit electrically connected to the processor and the electric tool apparatus,
wherein the processor is configured to obtain the torque test data and the torque original data from the force-multiplier-end memory; the processor is configured to transmit the torque test data and the torque original data to the electric tool apparatus through the force-multiplier-end signal-transmitting circuit.

3. The electric tool system of claim 2, wherein the electric tool apparatus comprises:
a tool-end signal-transmitting circuit electrically connected to the force-multiplier-end signal-transmitting circuit; and
a control circuit electrically connected to the tool-end signal-transmitting circuit,
wherein the processor is configured to transmit the torque test data and the torque original data to the control circuit through the force-multiplier-end signal-transmitting circuit and the tool-end signal-transmitting circuit; the control circuit is configured to calculate the torque test data and the torque original data to obtain the torque correction data; the control circuit is configured to drive the force-multiplier apparatus to rotate based on the torque correction data.

4. The electric tool system of claim 3, wherein the electric tool apparatus further comprises:
a tool-end memory electrically connected to the control circuit,
wherein the control circuit is configured to transmit the torque correction data to the tool-end memory to store the torque correction data; the control circuit is configured to drive the force-multiplier apparatus to rotate based on the torque correction data stored in the tool-end memory.

5. The electric tool system of claim 4, wherein the force-multiplier-end signal-transmitting circuit and the tool-end signal-transmitting circuit are conductive pins, connectors, or wireless transmission circuits.

6. The electric tool system of claim 5, wherein the electric tool apparatus further comprises:
a power-transmitting group connected to the control circuit; and
a tool force-outputting-end structure connected to the power-transmitting group and the force-multiplier apparatus,
wherein the force-multiplier apparatus further comprises:
a gear set connected to the processor;
a force-multiplier force-outputting-end structure connected to the gear set; and
a force-multiplier force-inputting-end structure connected to the gear set and the tool force-outputting-end structure,
wherein the control circuit is configured to drive the power-transmitting group to drive the tool force-outputting-end structure to rotate based on the torque correction data stored in the tool-end memory, so that the force-multiplier force-inputting-end structure is configured to be rotated by the tool force-outputting-end structure to drive the gear set, so that the gear set is configured to be driven by the force-multiplier force-inputting-end structure to rotate the force-multiplier force-outputting-end structure.

7. A force-multiplier torque-testing system comprising:
a torque-testing apparatus; and
a force-multiplier apparatus connected to the torque-testing apparatus,
wherein the torque-testing apparatus is configured to test the force-multiplier apparatus to obtain a torque test data; the torque-testing apparatus is configured to transmit the torque test data to the force-multiplier apparatus; the force-multiplier apparatus is configured to store the torque test data.

8. The force-multiplier torque-testing system of claim 7, wherein the force-multiplier apparatus comprises:
a force-multiplier-end memory configured to store the torque test data;
a processor electrically connected to the force-multiplier-end memory; and
a force-multiplier-end signal-transmitting circuit electrically connected to the processor and the torque-testing apparatus,
wherein the torque-testing apparatus comprises:
a detection shaft structure connected to the force-multiplier apparatus;
a testing-end signal-transmitting circuit electrically connected to the force-multiplier-end signal-transmitting circuit; and
a torque-testing circuit electrically connected to the testing-end signal-transmitting circuit and connected to the detection shaft structure,
wherein the torque-testing circuit is configured to test the force-multiplier apparatus through the detection shaft structure to obtain the torque test data; the torque-testing circuit is configured to transmit the torque test data to the processor through the testing-end signal-transmitting circuit and the force-multiplier-end signal-transmitting circuit; the processor is configured to transmit the torque test data to the force-multiplier-end memory to store the torque test data.

9. The force-multiplier torque-testing system of claim 8, wherein the force-multiplier apparatus further comprises:
a gear set connected to the processor;
a force-multiplier force-outputting-end structure connected to the gear set and the detection shaft structure; and
a force-multiplier force-inputting-end structure connected to the gear set,
wherein the force-multiplier force-inputting-end structure is configured to be rotated to drive the gear set, so that the gear set is configured to be driven by the force-multiplier force-inputting-end structure to rotate the force-multiplier force-outputting-end structure to drive the detection shaft structure, so that the torque-testing circuit is configured to test the force-multiplier apparatus through the detection shaft structure to obtain the torque test data,
wherein the torque-testing apparatus further comprises:
a display electrically connected to the torque-testing circuit,
wherein the torque-testing circuit is configured to transmit the torque test data to the display to display the torque test data.

10. The force-multiplier torque-testing system of claim 9, wherein the force-multiplier-end signal-transmitting circuit and the testing-end signal-transmitting circuit are conductive pins, connectors, or wireless transmission circuits.
